(19) United States
(12) Patent Application Publication
(10) Pub. No.: US 2026/0066386 A1
(43) Pub. Date: Mar. 5, 2026

(54) Battery Apparatus and Method for Cooling Battery Apparatus

(71) Applicant: SK On Co., Ltd., Seoul (KR)

(72) Inventors: Keun Woo CHOI, Daejeon (KR); Gyu Ran LEE, Daejeon (KR); Yang Kyu CHOI, Daejeon (KR); Seo Roh RHEE, Daejeon (KR); Ju Young JEONG, Daejeon (KR); Sung Min HONG, Daejeon (KR)

(21) Appl. No.: 19/208,791

(22) Filed: May 15, 2025

(30) Foreign Application Priority Data
Aug. 28, 2024 (KR) 10-2024-0115680

(51) Int. Cl. H01M 10/6556; H01M 10/613; H01M 10/633; H01M 10/6554; H01M 10/6568; H01M 50/211; H01M 50/505

(52) U.S. Cl. CPC H01M 10/6556; H01M 10/613; H01M 10/633; H01M 10/6554; H01M 10/6568; H01M 50/211; H01M 50/505

(57) ABSTRACT

The present disclosure relates to a battery apparatus and a method for a cooling battery apparatus, the present disclosure may include a battery apparatus including: a stack housing accommodating a plurality of battery cells and provided in plural; a cooling plate facing the stack housing; and a cooling channel provided in the cooling plate and having a coolant flow space in which a coolant flows, and the cooling channel may include regions in which values of a cross-sectional area of the coolant flow space are different from each other.

### CROSS-REFERENCE TO RELATED APPLICATION(S)

This patent document claims the priority and benefits of Korean Patent Application No. 10-2024-0115680 filed on Aug. 28, 2024, the disclosure of which is incorporated herein by reference in its entirety.

### TECHNICAL FIELD

The present disclosure relates to a battery apparatus and a method for a cooling battery apparatus.

### BACKGROUND

Batteries are widely used in small electronic devices such as mobile phones and laptop computers as well as in medium and large mechanical devices such as electric vehicles (EV), and have the advantage of being rechargeable and reusable.

An electrode assembly may be configured with an electrode plate including a cathode plate and an anode plate, and a separator separating the cathode plate and the anode plate. An electrode assembly manufactured in a stack type, a stack-folding type, a roll type, or the like, may be stored in a case selected according to the purpose of use such as a pouch type, a square type, a cylindrical type, or the like, and after injecting an electrolyte thereinto, the case may be sealed to manufacture a battery cell.

A plurality of battery cells may be stored in a stack housing, and a plurality of battery cells may be connected to a busbar to form a battery apparatus. The battery apparatus may be, for example, a battery module and/or a battery pack.

The battery apparatus may generate heat during use, and a coolant may be utilized to cool the battery apparatus.

### SUMMARY

According to an aspect of the present disclosure, a battery apparatus having improved cooling performance and cooling efficiency and a method for cooling the battery apparatus are provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

A battery apparatus according to an embodiment of the present disclosure may include: a stack housing accommodating a plurality of battery cells and provided in plural; a cooling plate facing the stack housing; and a cooling channel provided in the cooling plate and having a coolant flow space in which a coolant flows, and the cooling channel may include regions in which values of a cross-sectional area of the coolant flow space are different from each other.

In an example embodiment, in the cooling plate, an edge may be disposed outside an edge of the plurality of stack housings, and the coolant flow space may include: a cross-sectional area increasing region in which a cross-sectional area increases in a flow direction of a coolant; and a cross-sectional area decreasing region in which the cross-sectional area decreases in the flow direction of the coolant, and the cross-sectional area increasing region and the cross-sectional area decreasing region may be disposed outside the edge of the plurality of stack housings.

In an example embodiment, the coolant flow space may include: a plurality of stack cooling regions facing the plurality of stack housings; and at least one outer cooling region connected to the plurality of stack cooling regions and not facing the plurality of stack housings, and the at least one outer cooling region may include: the cross-sectional area increasing region and the cross-sectional area decreasing region.

In an example embodiment, at least one of the plurality of stack cooling regions may include: at least one first extension portion extending in a stacking direction in which the plurality of battery cells are stacked.

In an example embodiment, at least one of the plurality of stack cooling regions may include: a plurality of first extension portions; and at least one second extension portion connecting the plurality of first extension portions, and at least one of the plurality of stack cooling regions may be disposed in a curved manner.

In an embodiment, the plurality of first extensions may be spaced apart from each other by a first interval.

In an embodiment, the battery apparatus may include: an inlet connected to the coolant flow space and through which the coolant is introduced; and an outlet connected to the coolant flow space and through which the coolant is discharged, and the at least one outer cooling region may include: a first outer cooling region extending from the inlet and facing a separation space formed between the plurality of stack housings; and a plurality of second outer cooling regions facing a side space formed between edges of the plurality of stack housings and an edge of the cooling plate.

In an embodiment, the first outer cooling region may include: the cross-sectional area decreasing region, and at least one of the plurality of second outer cooling regions may include: the cross-sectional area increasing region.

In an embodiment, the coolant flow space may further include: a plurality of stack inlet regions through which the coolant flowing into the plurality of stack cooling regions flows; and a plurality of stack discharge regions through which the coolant discharged from the plurality of stack cooling regions flows, and the coolant supplied from the first outer cooling region may be introduced into the plurality of stack inlet regions, and the coolant discharged from the plurality of stack discharge regions may flow in the plurality of second outer cooling regions.

In an embodiment, the cross-sectional area increasing region may include: a first flow region disposed to follow a first stack discharge region of a first stack housing in the flow direction of the coolant and having a first cross-sectional area; a second flow region integrating the first flow region and a second stack discharge region of a second stack housing adjacent to the first stack housing and having a second cross-sectional area; and a third flow region integrating the second flow region and a third stack discharge region of a third stack housing adjacent to the second stack housing, and having a third cross-sectional area, and among the first cross-sectional area, the second cross-sectional area and the third cross-sectional area, a value of the third cross-sectional area is the largest.

In an embodiment, the cross-sectional area decreasing region may include: a fourth flow region supplying the coolant to a fifth stack inlet region of a fifth stack housing facing a fourth stack housing adjacent to the third stack housing in a stacking direction in which a plurality of battery cells are stacked, and having a fourth cross-sectional area; a fifth flow region disposed to follow the fourth flow region in the flow direction of the coolant and having a fifth cross-sectional area; and a sixth flow region disposed to follow the fifth flow region in the flow direction of the coolant and having a sixth cross-sectional area, and, among the fourth cross-sectional area, the fifth cross-sectional area and the sixth cross-sectional area, a value of the sixth cross-sectional area may be the lowest.

In an embodiment, in the cooling channel, the inlet, the coolant flow space and the outlet may form a closed loop, and the coolant may circulate through the closed loop.

In an embodiment, the cooling plate may be formed of a material including aluminum, and the cooling channel may be a hollow portion formed in the cooling plate.

The battery apparatus may further include: an apparatus case accommodating the plurality of stack housings and the cooling plates, and including the separation space and the side space; and a busbar assembly connected to the plurality of battery cells and disposed in the side space.

A battery apparatus according to another embodiment of the present disclosure may include: an apparatus case; a plurality of stack housings accommodated in the apparatus case and accommodating a plurality of battery cells; a cooling plate facing the plurality of stack housings and including a coolant flow space therein; an inlet connected to the coolant flow space and through which a coolant flows; and an outlet connected to the coolant flow space and through which the coolant is discharged, and the plurality of stack housings may include: at least one inlet stack housing and at least one outlet stack housing, the at least one inlet stack housing and the at least one outlet stack housing are separated from each other to form a separation space, and the coolant flow space may include regions in which values of a cross-sectional area of the coolant flow space are different from each other, and a cross-sectional area decreasing region, which is a region in which a value of a cross-sectional area of the coolant flow space decreases, may be disposed to face the separation space.

In an embodiment, the cross-sectional area increasing region, which is a region in which a value of the cross-sectional area of the coolant flow space increases, may be disposed outside the separation space.

Meanwhile, the present disclosure according to another aspect provides a method for cooling a battery apparatus.

A method for cooling a battery apparatus according to an embodiment of the present disclosure may include: to cool the battery apparatus, a coolant flow operation of allowing a coolant to flow in the coolant flow space in a stacking direction of the plurality of battery cells; and a coolant control operation of changing at least one of a flow velocity and a flow rate of the coolant in the coolant flow space.

In an embodiment, the coolant control operation may include: a decreasing operation of linearly decreasing the flow velocity; and an increasing operation of linearly increasing the flow velocity.

According to an aspect of the present disclosure, a battery apparatus having improved cooling performance and cooling efficiency and a method for cooling the battery apparatus may be provided.

Additionally, the present disclosure may be widely applied in devices of green technology fields such as solar power generation and wind power generation.

Additionally, the present disclosure may be applied to eco-friendly devices such as eco-friendly electric vehicles and hybrid vehicles to ameliorate the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic exploded perspective view of a battery apparatus according to an embodiment of the present disclosure.

FIG. 2 is a schematic plan view of a battery apparatus according to an embodiment of the present disclosure.

FIG. 3 is a partially exploded perspective view of a cooling plate and a stack housing according to an embodiment of the present disclosure.

FIG. 4 is a schematic diagram of a coolant flow of a battery apparatus according to an embodiment of the present disclosure, and is illustrated from a perspective of a plan view.

FIG. 5 is a schematic diagram of an inlet stack housing including four stack housings disposed in one row among a plurality of stack housings.

FIG. 6 is a schematic diagram of an outlet stack housing including four stack housings disposed in two rows among a plurality of stack housings.

FIG. 7 is a partially exploded perspective view of a battery apparatus according to an embodiment of the present disclosure.

FIG. 8 is a schematic diagram illustrating an analysis result of a coolant flow velocity of a battery apparatus according to an embodiment of the present disclosure.

FIG. 9 schematically illustrates a method for cooling a battery apparatus according to an embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis illustrated in the drawings is a longitudinal direction of a battery cell 10, a Y-axis is a thickness direction or a stacking direction of the battery cell 10, and a Z-axis is a width direction or a height direction of the battery cell 10. However, these are directions arbitrarily set for the convenience of understanding, and the above-described directions may be changed.

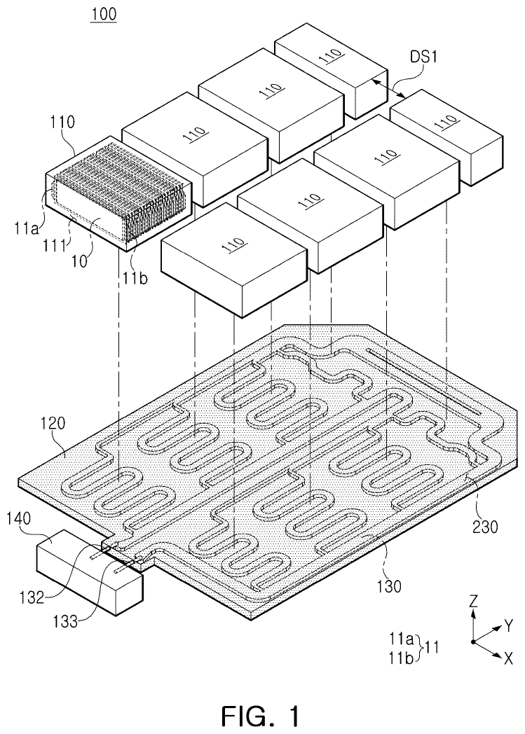

FIG. 1 is a schematic exploded perspective view of a battery apparatus 100 according to an embodiment of the present disclosure.

As illustrated in FIG. 1, the battery apparatus 100 according to an embodiment of the present disclosure may include a stack housing 110 accommodating a plurality of battery cells 10 and provided in plural, a cooling plate 120 facing the stack housing 110, and a cooling channel 130 provided in the cooling plate 120 and having a coolant flow space 230 through which coolant flows. The cooling channel 130 may include regions in which a cross-sectional area of the coolant flow space 230 has different values.

In an embodiment, the cooling channel 130 may include a flow path disposed inside the cooling plate 120. For example, the cooling channel 130 may be a pipe disposed inside the cooling plate 120 or a hollow space formed in the cooling plate 120. The hollow space may be, for example, an empty space formed inside the cooling plate 120. Additionally, for example, the cooling channel 130 may be a heat sink.

The coolant flow space 230 may be a space or a region in which a coolant may flow in the pipe or the hollow space. In the coolant flow space 230, the coolant may follow the flow in pipelines.

In an embodiment, the battery apparatus 100 may include an inlet 132 connected to the coolant flow space 230 and through which the coolant is introduced, and an outlet 133 connected to the coolant flow space 230 and through which the coolant is discharged. The coolant may be introduced into the coolant flow space 230 through the inlet 132, and may be discharged through the outlet 133 through the coolant flow space 230 provided inside the cooling plate 120.

In an embodiment, the inlet 132 and the outlet 133 may include a pipe. The coolant may flow inside the pipe.

At least one of at least a partial region of the inlet 132 and at least a partial region of the outlet 133 may be disposed inside the cooling plate 120, and an entire region of the inlet 132 and an entire region of the outlet 133 may be disposed outside the cooling plate 120. However, this is not necessarily limited by the present disclosure.

In some cases, at least one of a sealing member, a packing member, and a coupling member may be provided in a connection region between the inlet 132 and the cooling channel 130 and a connection region between the outlet 133 and the cooling channel 130.

In an embodiment, the inlet 132 and the outlet 133 may be connected to a cooling portion 140. The cooling portion 140 may include at least one of a heat exchanger, a pump, a condenser, and a valve.

The cooling portion 140 may supply a coolant to the coolant flow space 230 through the inlet 132 at an appropriate pressure, and may exchange heat with the coolant discharged through the outlet 133. The cooling portion 140 may cool the coolant discharged through the outlet 133 by utilizing air cooling or water cooling, or may cool the coolant by utilizing another cooling fluid other than air or water.

In an embodiment, the coolant flowing in the coolant flow space 230 may be water. However, the type of the coolant is not necessarily limited by the present disclosure.

In an embodiment, the cooling plate 120 may be disposed in a lower portion of a plurality of stack housings 110 in a −Z-direction.

The cooling plate 120 may face or contact the plurality of stack housings 110. In some cases, a heat transfer material or an adhesive material may be further provided between the plurality of stack housings 110 and the cooling plate 120.

The plurality of stack housings 110 may include an accommodating space 111. A plurality of battery cells 10 may be stacked or arranged in the accommodating space 111.

The plurality of battery cells 10 may be stacked or arranged in the thickness direction (Y-axis direction) of the battery cells 10 in the accommodating space 111.

The battery cell 10 may be a secondary battery or a lithium-ion battery. The battery cell 10 may have an electrode assembly including a cathode plate, an anode plate, and a separator inside an outer material, and an electrolyte.

The battery cell 10 may be a pouch-type battery cell 10, and the battery cell 10 may be a bidirectional battery cell 10 or a unidirectional battery cell 10 depending on a position in which an electrode lead 11 is drawn out from the outer material.

Hereinafter, the bidirectional battery cell 10 in which a first electrode lead 11a is drawn out from one side of the battery cell 10 and a second electrode lead 11b is drawn out from the other side of the battery cell 10 will be described as an example, but the type of the battery cell 10 is not necessarily limited by the present disclosure, and the battery cell 10 may be another type of battery cell, other than a secondary battery, a lithium ion battery, or a pouch-type battery.

The coolant flow space 230 in the cooling plate 120 may be disposed in a curved manner. For example, the coolant flow space 230 may include a curved region and a straight region. Each of the curved region and the straight region may be provided in plural.

The curved region described above may be a section (or region) in which a shape of the coolant flow space 230 is curved in a thickness direction cross-section or plane (X-Y plane) of the battery cell 10. The curved region may be the entire coolant flow space 230 corresponding to a section in which the shape of the coolant flow space 230 is curved in the plane (X-Y plane).

That is, the curved region may denote the volume of the coolant flow space 230 or a pipe forming the coolant flow space 230 in the section in which the shape of the coolant flow space 230 is a curve in the plane (X-Y plane).

A straight region may also be a section (or area) in which the shape of the coolant flow space 230 is a straight line in the thickness direction cross-section or plane (X-Y plane) of the battery cell 10. The straight region may be the entire coolant flow space 230 corresponding to the section in which the shape of the coolant flow space 230 is a straight line, in the plane (X-Y plane).

That is, the straight region of the coolant flow space 230 may denote the volume of the coolant flow space 230 or a pipe forming the coolant flow space 230 in the section in which the shape of the coolant flow space 230 is a straight line in the plane (X-Y plane). Here, the volume of the pipe may be calculated by taking an outer line of the coolant flow space 230 as a bottom surface in the plane (X-Y plane) and a Z-axis (height direction of the battery cell 10) as a height.

The meaning of “region of the coolant flow space 230” described below may be a specific region of the coolant flow space 230 in the thickness direction cross-section or plane (X-Y plane) of the battery cell 10 and an entire region extending from the specific region in a Z-axis direction.

That is, the volume of the specific region of the coolant flow space 230 may be calculated by taking an outer line of the specific region of the coolant flow space 230 as a bottom surface in the thickness direction cross-section or plane (X-Y plane) of the battery cell 10 and the Z-axis as the height. The meaning of “region” described below may denote the volume of a space or a region in which the coolant is capable of flowing in the coolant flow space 230.

The coolant flow space 230 may also face the plurality of stack housings 110 and a separation space DS1 formed between the plurality of stack housings 110. The separation space DS1 may include not only a space formed by the plurality of stack housings 110 being spaced apart from each other in the X-axis direction, but also a space formed by a plurality of stack housings being spaced apart from each other in the Y-axis direction. The separation space DS1 may be a space formed in an apparatus case 150.

The coolant flow space 230 may face or contact a cooling target object to cool the cooling target object. In an embodiment, the cooling target object may be a plurality of stack housings 110 and a plurality of battery cells 10.

In an embodiment, the coolant flow space 230 may face the plurality of stack housings 110 with a surface of the cooling plate 120 and/or the heat transfer material interposed therebetween. Accordingly, the coolant may cool the plurality of battery cells 10. Hereinafter, the expression “the coolant flow space 230 faces the stack housing 110” may denote that the coolant flow space 230, for example, the surface of the pipe, faces the surface of the cooling plate 120 and/or a surface of the stack housing 110 with a heat transfer material interposed therebetween.

In an embodiment, the straight region of the coolant flow space 230 may be a straight line, parallel to the Y-axis. For example, the straight region of the coolant flow space 230 may be disposed parallel to the stacking direction of the plurality of battery cells 10.

Additionally, for example, the plurality of straight regions may be disposed parallel to a stacking direction of the plurality of battery cells 10, and the plurality of straight regions may be spaced apart from each other by a certain distance and may be parallel to each other. Here, the plurality of straight regions may be spaced apart from each other in a longitudinal direction (X-axis direction) of the battery cell 10.

The straight region of the coolant flow space 230 may face a region disposed between the first electrode lead 11a and the second electrode lead 11b in the battery cell 10, may face the first electrode lead 11a and may face the second electrode lead 11b.

Additionally, a plurality of straight regions may face a region disposed between the first electrode lead 11a and the second electrode lead 11b in the battery cell 10, and may face the first electrode lead 11a and may face the second electrode lead 11b.

The straight regions may extend in a stacking direction of the plurality of battery cells 10 from a lower portion of the plurality of battery cells 10 disposed in the accommodating space 111 of one stack housing 110 in a −Z-direction.

According to the straight regions, the plurality of battery cells 10 disposed in one stack housing 110 may be uniformly cooled. Additionally, occurrence of cooling deviation between the plurality of battery cells 10 disposed in one stack housing 110 may be prevented.

The plurality of stack housings 110 may be disposed in an upper portion of the cooling plate 120 in the +Z-direction. The plurality of stack housings 110 may be spaced apart from each other by a certain distance.

The plurality of stack housings 110 may be spaced apart from each other in a thickness direction (Y-direction) of the battery cell 10 and/or a length direction (X-direction) of the battery cell 10.

The plurality of straight regions in the coolant flow space 230 may face each of the plurality of stack housings 110. Accordingly, the plurality of stack housings 110 may be uniformly cooled, and the occurrence of cooling deviation between the plurality of stack housings 110 may be prevented.

In an embodiment, a space formed by the plurality of stack housings 110 being spaced apart in the length direction (X-direction) of the battery cell 10 may be a separation space DS1. The coolant flow space 230 may be provided in the cooling plate 120 so as to face the separation space DS1.

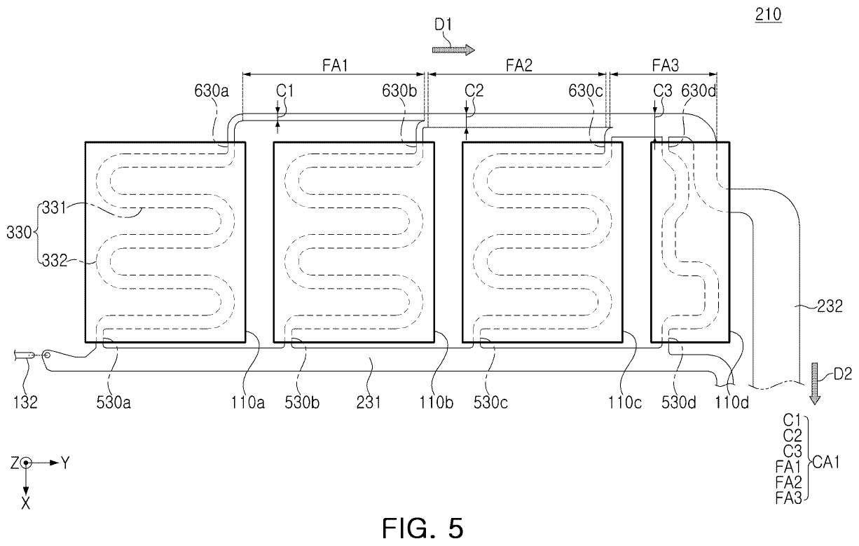

For example, the coolant flow space 230 facing the separation space DS1 may include a region which is a straight line, parallel to the thickness direction (Y-direction) of the battery cell 10. The coolant flow space 230 facing the separation space DS1 may include a main flow region 231 (see FIG. 5) described below.

Additionally, in an embodiment, the coolant flow space 230 may include regions in which values of cross-sectional area in a height direction cross-section (X-Z plane) of the battery cell 10 are different from each other.

For example, the coolant flow space 230 may include a region in which the cross-sectional area increases in the flow direction of the coolant and a region in which the cross-sectional area decreases in the flow direction of the coolant.

The cross-sectional area of the coolant flow space 230 may change in the flow direction of the coolant. Accordingly, the battery apparatus 100 may change a flow velocity, a flow rate, and pressure of the coolant in the coolant flow space 230. Accordingly, the battery apparatus 100 may have different flow velocities, different flow rates, and different pressures of the coolant for each region of the cooling plate 120. Accordingly, cooling suitable for the characteristics of each region and each position of the battery apparatus 100 may be implemented.

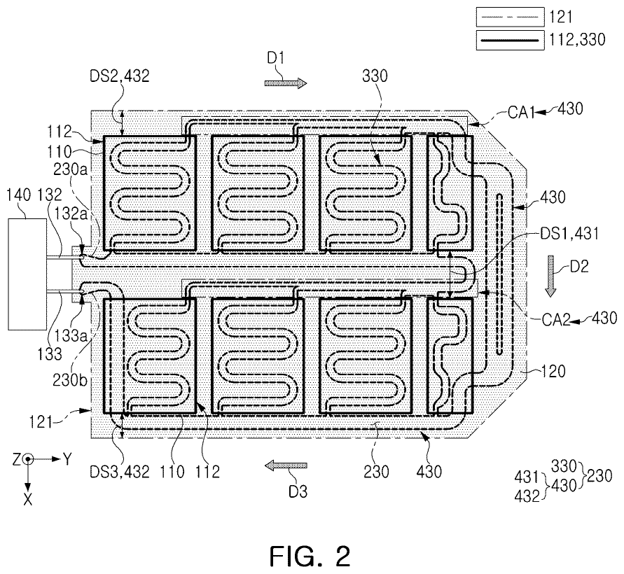

FIG. 2 is a schematic plan view of the battery apparatus 100 according to an embodiment of the present disclosure.

As illustrated in FIG. 2, in an embodiment, the cooling plate 120 may has an edge disposed outside an edge of the plurality of stack housings 110. Additionally, the coolant flow space 230 may include a cross-sectional area increasing region CA1, which is a region in which a cross-sectional area increases in the flow direction of the coolant, and a cross-sectional area decreasing region CA2, which is a region in which the cross-sectional area decreases in the flow direction of the coolant, and the cross-sectional area increasing region CA1 and the cross-sectional area decreasing region CA2 may be disposed outside the edge of the plurality of stack housings 110.

The cross-sectional area increasing region CA1 and the cross-sectional area decreasing region CA2 may be disposed on the outside or an external portion of a plurality of first edges 112 in a direction away from the battery cell 10, based on the first edge 112 of the plurality of stack housings 110.

The “outside” may denote that a component is further away in terms of distance or position with respect to any one of the criteria.

An edge of the stack housing 110 may include a first edge 112. The first edge 112 may be an outer line of the stack housing 110. The first edge 112 may be provided in each of the plurality of stack housings 110.

In an embodiment, the first edge 112 may be a polygon. For example, the first edge 112 may be a square.

An edge of the cooling plate 120 may include a second edge 121. The second edge 121 may be an outer line of the cooling plate 120. The second edge 121 may be disposed outside the first edge 112. The second edge 121 may be disposed on the outside or an external portion of the first edge 112 in a direction away from the battery cell 10 based on the first edge 112.

For example, an area of the cooling plate 120 in a cross-section (X-Y plane) in a stacking direction of the battery cell 10 may exceed an area of the entire plurality of stack housings 110.

In an embodiment, the plurality of stack housings 110 may contact or face the cooling plate 120, or may be accommodated in the cooling plate 120. In this case, an area of the cooling plate 120 in the X-Y plane may be equal to or greater than the sum of areas of each of the plurality of stack housings 110, an area of the separation space DS1, an area of a first side space DS2, and an area of a second side space DS3.

An outer line of the stack housing 110 may be the first edge 112, and the first edge 112 may be disposed inside the second edge 121 based on the battery cell 10. The inside of the second edge 121 may denote the inside of the cooling plate 120 in a direction oriented toward the centroid of the cooling plate 120 in the X-Y plane.

“Inside” or “inside” may denote that a component is disposed closer in terms of distance or position with respect to any one standard.

In an embodiment, the coolant flow space 230 may include a plurality of stack cooling regions 330 facing the plurality of stack housings 110 and at least one outer cooling region 430 connected to the plurality of stack cooling regions 330 and not facing the plurality of stack housings 110. In an embodiment, the at least one outer cooling region 430 may include a cross-sectional area increasing region CA1 and a cross-sectional area decreasing region CA2.

The stack cooling region 330 may be a coolant flow space 230 facing the stack housing 110, among the coolant flow spaces 230. The stack cooling region 330 may be a coolant flow space 230 facing a lower portion of the stack housing 110 in the −Z-direction, among the coolant flow spaces 230.

The stack cooling region 330 may be a region of the coolant flow space 230 that faces the first edge 112 of the stack housing 110. In addition, the stack cooling region 330 may be the coolant flow spaces 230 that faces a region corresponding to the inside of the first edge 112 of the stack housing 110, or the stack cooling region 330 may be the coolant flow space 230 that faces a region located in an interior of the first edge 112 of the stack housing 110 in a direction oriented toward a centroid of the stack housing 110.

The stack cooling region 330 may also include a coolant flow space 230 facing the first edge 112. The stack cooling region 330 may be a coolant flow space 230 disposed inside the first edge 112 in a direction oriented toward the first edge 112 and a centroid of the first edge 112.

The number of the plurality of stack cooling regions 330 may be the same as the number of the plurality of stack housings 110. For example, one stack cooling region 330 may face one stack housing 110. Additionally, the plurality of stack cooling regions 330 may be connected to each other.

The outer cooling region 430 may be a region other than the stack cooling region 330 among the coolant flow space 230. The outer cooling region 430 may not face the plurality of stack housings 110.

The outer cooling region 430 may not face the plurality of stack housings 110 in the Z-axis direction in a thickness direction plane (X-Y plane) of the battery cell.

The outer cooling region 430 may be a coolant flow space 230 disposed between the first edge 112 projected onto the cooling plate 120 and the second edge 121 of the cooling plate 120, by projecting the first edge 112 of the stack housing 110 onto the cooling plate 120 in the −Z-direction.

The outer cooling region 430 may be a coolant flow space 230 that faces or contacts the surface of the cooling plate 120. The surface of the cooling plate 120 may be a region located between the first edge 112 projected onto the cooling plate 120 and the second edge 121.

In an embodiment, at least one outer cooling region 430 may include a first outer cooling region 431 extending from the inlet 132 and facing the separation space DS1 formed between the plurality of stack housings 110, and a plurality of second outer cooling regions 432 facing a side space formed between edges of the plurality of stack housings 110 and an edge of the cooling plate 120.

For example, at least one outer cooling region 430 may include a plurality of outer cooling regions 430. The plurality of outer cooling regions 430 may include a first outer cooling region 431 and a plurality of second outer cooling regions 432.

The first outer cooling region 431 may be a coolant flow space 230 facing the separation space DS1. The first outer cooling region 431 may face the separation space DS1 disposed in an upper portion in the +Z-direction of the cooling plate 120.

The separation space DS1 may be formed by the plurality of stack housings 110 being spaced apart in the longitudinal direction (X-direction) of the battery cell 10, and may be a space interposed between the plurality of stack housings 110 spaced apart from each other in the X-direction. The separation space DS1 may extend in the stacking direction (Y-direction) of the battery cell 10.

One of the plurality of second outer cooling regions 432 may be disposed between the second edge 121 and the first edge 112 disposed in an end of the cooling plate 120 in the −X-direction. Another one of the plurality of second outer cooling regions 432 may be disposed between the second edge 121 and the first edge 112 disposed in the end of the cooling plate 120 in the +X-direction.

The plurality of second outer cooling regions 432 may be spaced apart from each other in the X-Y plane with the stack cooling region 330 and the first outer cooling region 431 interposed therebetween.

The plurality of second outer cooling regions 432 may be disposed outside the first edge 112 of the stack housing 110 which is disposed in an outermost side in the longitudinal direction (X-direction) of the battery cell 10. Here, “outside” may denote the outside of the first edge 112 in a direction oriented from the first edge 112 toward the second edge 121.

In an embodiment, the cooling channel 130 may have an inlet 132, a coolant flow space 230, and an outlet 133, which may form a closed loop, and the coolant may circulate through the closed loop.

For example, the coolant flow space 230 of the cooling channel 130 may be a single pipe or hollow portion having a first opening 230a and a second opening 230b. The coolant flow space 230 may include a flow portion extending from the first opening 230a and distributed over an entire region of the cooling plate 120.

The flow portion may connect the first opening 230a and the second opening 230b. The flow portion may include a plurality of stack cooling regions 330 and a plurality of outer cooling regions 430. The coolant may be introduced into the first opening 230a, may pass through the flow portion, and then be discharged through the second opening 230b.

In an embodiment, in the thickness direction cross-section (X-Y plane) of the battery cell 10, the first opening 230a may extend from the first outer cooling region 431, and the second opening 230b may also extend from the first outer cooling region 431.

The first opening 230a may be connected to the inlet 132, and the second opening 230b may be connected to the outlet 133. In the cross-section in the thickness direction (X-Y plane) of the battery cell 10, a connection region 132a between the coolant flow space 230 and the inlet 132 and a connection area 133a between the coolant flow space 230 and the outlet 133 may overlap the first outer cooling region 431 or may be included in the first outer cooling region 431.

In an embodiment, the first outer cooling region 431 may include a cross-sectional area decreasing region CA2, and at least one of the plurality of second outer cooling regions 432 may include a cross-sectional area increasing region CA1.

Specifically, the coolant may be introduced into the first opening 230a of the coolant flow space 230, may pass through the stack cooling region 330, and may then be introduced into the second outer cooling region 432 including the cross-sectional area increasing region CA1.

In the second outer cooling region 432 including the above cross-sectional area increasing region CA1, the coolant may flow in a first flow direction D1. The coolant flow space 230 may have a plurality of values of the cross-sectional area (area in the X-Z plane) in the Z-axis direction in the cross-sectional area increasing region CA1. A plurality of cross-sectional area values may increase toward the first flow direction D1.

For example, the cross-sectional area of the coolant flow space 230 in the cross-sectional area increasing region CA1 may increase linearly or gradually in the first flow direction D1. The first flow direction D1 may be a stacking direction (Y-direction) of the plurality of battery cells 10. Accordingly, the flow velocity of the coolant in the cross-sectional area increasing region CA1 may decrease toward the first flow direction D1.

In the X-Y plane, the cross-sectional area increasing region CA1 in the coolant flow space 230 may face each of the side surfaces of the plurality of stack housings 110. The flow direction of the coolant flow space 230 may change in the end of the cross-sectional area increasing region CA1 in the +Y-direction.

For example, the coolant flow space 230 may flow in a second flow direction D2 in the end of the cross-sectional area increasing region CA1 in the +Y-direction. The second flow direction D2 may be a direction, intersecting or perpendicular to the first flow direction D1. The second flow direction D2 may be a direction oriented from the cross-sectional area increasing region CA1 toward another second outer cooling region 432, that is, a second outer cooling region 432 that does not include the cross-sectional area increasing region CA1.

Meanwhile, the cross-sectional area decreasing region CA2 may decrease the cross-sectional area of the coolant flow space 230 in a direction opposite to a direction in which the cross-sectional area of the coolant flow space 230 increases in the cross-sectional area increasing region CA1.

The coolant flowing in the cross-sectional area decreasing region CA2 may be a coolant introduced from the first opening 230a, and may be the coolant that does not flow in the cross-sectional area increasing region CA1. The coolant flowing in the cross-sectional area decreasing region CA2 may be supplied to another stack cooling area 330 facing the plurality of stack cooling regions 330 through which the coolant is discharged, rather than the plurality of stack cooling areas 330 through which the coolant is discharged to the cross-sectional area increasing region CA1.

In an embodiment, the coolant in the first outer cooling region 431 including the cross-sectional area decreasing region CA2 may flow in a third flow direction D3. The third flow direction D3 may be a direction opposite to the first flow direction D1, and may be in a direction oriented from the stack housing 110 disposed in an outermost side in the +Y-direction toward the outlet 133.

In the cross-sectional area decreasing region CA2, the cross-sectional area of the coolant flow space 230 may be linearly or gradually reduced in the third flow direction D3. The cross-sectional area of the coolant flow space 230 may be a cross-sectional area in a height direction of the battery cell 10 (cross-sectional area in the X-Z plane). Accordingly, the flow velocity of the coolant in the cross-sectional area decreasing region CA2 may increase toward the third flow direction D3.

The coolant close to the inlet 132 may have a relatively low temperature, and the coolant close to the outlet 133 may have a relatively high temperature. Accordingly, the present disclosure may increase the flow velocity of the coolant having a relatively low temperature in the cross-sectional area increasing region CA1, which is a region relatively close to the inlet 132 in the direction of the flow of the coolant, so that the coolant having a relatively low temperature may quickly flow in a region (e.g., a cooling target area) facing an entire region of the stack housing 110.

Additionally, in the present disclosure, the coolant having a relatively low temperature may be quickly introduced into a region (e.g., a cooling target region) facing the stack housing 110, the time for the coolant having a relatively low temperature to cool the stack housing 110 may also be increased.

Additionally, according to the cross-sectional area increasing region CA1 of the present disclosure, before the temperature of the relatively low temperature coolant discharged from the inlet 132 increases, the relatively low temperature coolant may be brought into contact with the widest region of the stack housing 110. Accordingly, the present disclosure may improve the cooling efficiency of the stack housing 110.

Additionally, by increasing the flow velocity of the coolant in the cross-sectional area decreasing region CA2, which is an area relatively close to the outlet 133 in the direction of the flow of the coolant, the coolant having a relatively high temperature may be quickly discharged to the outlet 133. Additionally, by increasing the flow velocity of the coolant, the stagnation of the flow of the coolant may be prevented. Accordingly, the coolant that has completed heat exchange with the battery cell 10 may be quickly re-cooled, and may shorten a cooling cycle. This may contribute to improving the cooling performance and cooling efficiency of the battery apparatus 100.

Meanwhile, the coolant discharged through the outlet 133 may be cooled in the cooling portion 140 and may then flows back into the inlet port 132, thereby circulating in the coolant flow space 230. The flow velocity of the coolant, the number of stack housings 110, the total length of the coolant flow space 230, the area of the cooling plate 120, and the like, are not necessarily limited by the present disclosure. Additionally, the pressure at which the coolant is supplied from the cooling portion 140 may be appropriately determined by considering the flow velocity of the coolant, the number of stack housings 110, the total length of the coolant flow space 230, the area of the cooling plate 120, and the like.

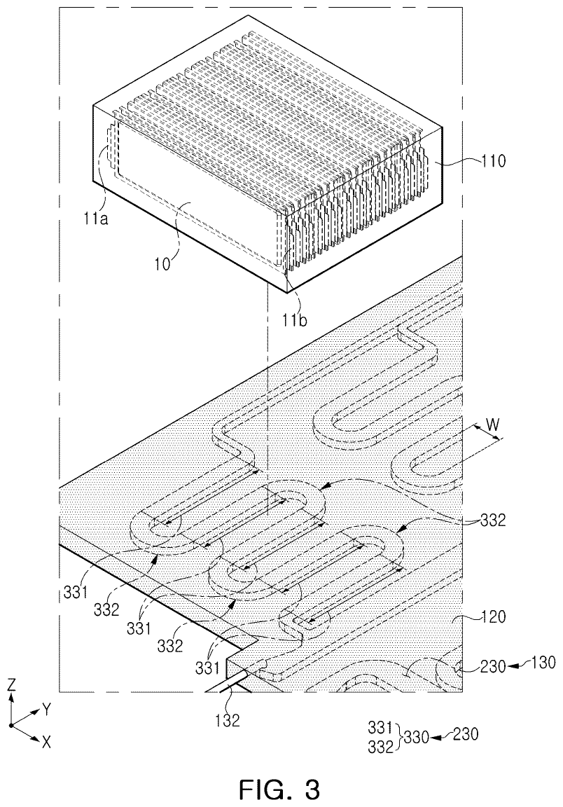

FIG. 3 is a partially exploded perspective view of the cooling plate 120 and the stack housing 110 according to an embodiment of the present disclosure.

As illustrated in FIG. 3, in an embodiment, at least one of the plurality of stack cooling regions 330 may include at least one first extension portion 331 extending in a stacking direction, which is a direction in which the plurality of battery cells 10 are stacked.

The first extension portion 331 may be a straight region in the coolant flow space 230, and may be a region parallel to the stacking direction in the coolant flow space 230.

At least one first extension portion 331 may include a plurality of first extension portions 331. The plurality of first extension portions 331 may be connected by at least one second extension portion 332.

For example, at least one second extension portion 332 may include a plurality of second extension portions 332. In the X-Y plane, the plurality of second extension portions 332 may be a straight line or a curved line.

The second extension portion 332 may extend in a direction intersecting or perpendicular to the first extension portion 331. The first extension portion 331 and the second extension portion 332 may be coolant flow spaces 230 disposed in the stack cooling region 330.

The first extension portion 331 and the second extension portion 332 may be provided in each of the plurality of stack cooling regions 330.

In an embodiment, the coolant flow space 230 may be disposed in a curved manner in the stack cooling region 330. In the stack cooling region 330, the first extension portion 331 and the second extension portion 332 may be connected or joined, and may form a curved shape of the coolant flow space 230 by connecting or coupling the first extension portion 331 and the second extension portion 332.

For example, a plurality of first extension portions 331 and a plurality of second extension portions 332 may be alternately disposed in the stack cooling region 330.

The plurality of first extension portions 331 may be disposed below the first electrode lead 11a in the −Z-direction and below the second electrode lead 11b in the −Z-direction. The plurality of first extension portions 331 may face the plurality of first electrode leads 11a and the plurality of second electrode leads 11b.

In an embodiment, one first extension portion 331 may face the first electrode leads 11a of the plurality of battery cells 10, and another first extension portion 331 may face the second electrode leads 11b of the plurality of battery cells 10. According to the first extension portion 331, the plurality of battery cells 10 may be uniformly cooled in one stack housing 110. Additionally, a cooling difference between the plurality of battery cells 10 may be prevented.

The battery cell 10 may have a relatively high temperature in a region adjacent to the first electrode lead 11a and a region adjacent to the second electrode lead 11b. Accordingly, as the plurality of first extension portions 331 face the first electrode lead 11a and the second electrode lead 11b, respectively, the cooling efficiency of the battery cell 10 may be improved.

Additionally, in an embodiment, at least one first extension portion 331 may be disposed to face a center of the battery cell 10 in the X-axis direction. At least one first extension portion 331 may be disposed to face the centers of the plurality of battery cells 10. According to the first extension portion 331, a heat transfer path in the battery cell 10 may increase, and the cooling efficiency of the center of the battery cell 10 in which the thermal resistance is dense may be improved.

In an embodiment, the plurality of first extension portions 331 disposed in one stack cooling region 330 may be spaced apart from each other by a first interval W.

The plurality of first extension portions 331 may be spaced apart from each other in a direction (X-direction), intersecting or perpendicular to the stacking direction of the battery cell 10. The first interval W may be a length of a straight line connecting the outer lines of a pair of first extension portions 331 in the X-axis direction. In this case, the straight line may be a straight line connecting the outer lines at the shortest distance.

According to the first interval W, an optimized number of first extension portions 331 may be provided in one stack cooling region 330. That is, a maximum cooling efficiency may be achieved with the minimum first extension portion 331.

In an embodiment, the first internal W may be 10 mm or more. Additionally, as an example, a first internal W1 may be 10 mm or more and 20 mm or less. Accordingly, the plurality of first extension portions 331 may be prevented from being excessively spaced apart from each other, thereby preventing the cooling performance from being reduced.

Additionally, a range in which heat exchange between the coolants existing in the plurality of first extension portions 331 facing each other may be set. Accordingly, cooling between the coolants flowing in the coolant flow space 230 may be induced, or a rapid temperature increase of the coolant may be prevented.

The above-described content may be applied to the plurality of stack cooling regions 330 facing the plurality of stack housings 110 with the same principle.

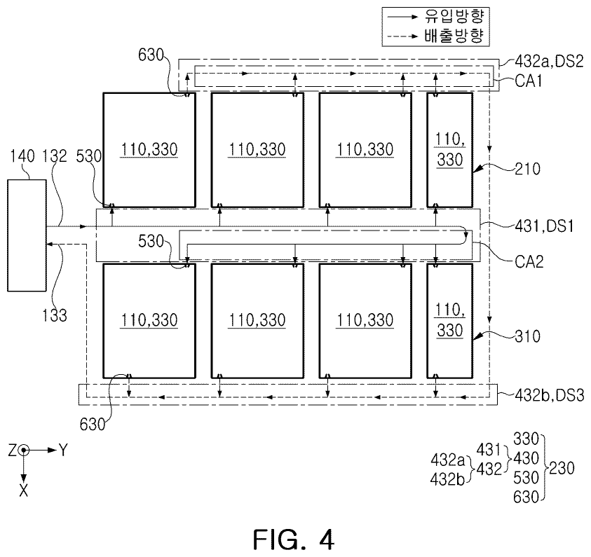

FIG. 4 is a schematic diagram of the coolant flow of the battery apparatus 100 according to an embodiment of the present disclosure, and is illustrated from the perspective of a plan view.

As illustrated in FIG. 4, the coolant flow space 230 according to an embodiment of the present disclosure may further include a plurality of stack inlet regions 530 through which the coolant flowing into a plurality of stack cooling regions 330 flows, and a plurality of stack discharge regions 630 through which the coolant discharged from the plurality of stack cooling regions 330 flows.

Here, the plurality of stack inlet regions 530 may be provided with coolant supplied from the first outer cooling region 431, and in the plurality of second outer cooling regions 432, the coolant discharged from the plurality of stack discharge regions 630 may flow.

Each of the plurality of stack housings 110 may face a plurality of stack cooling regions 330. The coolant flow space 230 may include a plurality of stack inlet regions 530 through which the coolant is supplied to each of the stack cooling regions 330. Additionally, the coolant flow space 230 may include a plurality of stack discharge regions 630 which passes through each stack cooling region 330 and into which the coolant discharged from each stack cooling region 330 flows.

The plurality of stack inlet regions 530 and the plurality of stack discharge regions 630 may face the stack housing 110, and may not face the stack housing 110 in some cases.

For example, the plurality of stack inlet regions 530 and the plurality of stack discharge regions 630 may be coolant flow spaces 230 parallel to the longitudinal direction (X-direction) of the battery cell 10. However, the present disclosure is not limited thereto.

In an embodiment, the plurality of stack housings 110 may include eight stack housings 110. Among the eight stack housings 110, four stack housings 110 may be disposed in a first row, and another four stack housings 110 may be disposed in a second row.

Among the plurality of stack housings 110, four stack housings 110 disposed in the first row may be arranged in the stacking direction (Y-direction) of the battery cells 10, and may be spaced apart from each other by a certain distance in the stacking direction (Y-direction) of the battery cells 10.

Among the plurality of stack housings 110, another four stack housings 110 disposed in the second row may be arranged in the stacking direction (Y-direction) of the battery cells 10, and may be spaced apart from each other by a certain distance in the stacking direction (Y-direction) of the battery cells 10.

The four stack housings 110 disposed in the first row and the four stack housings 110 disposed in the second row may be spaced apart from each other by a certain distance in the longitudinal direction (X-direction) of the battery cells 10. However, the number of stack housings 110 may be changed, and the number of rows in which the plurality of stack housings 110 are arranged may also be changed.

Meanwhile, as illustrated in FIGS. 2 and 4, in an embodiment of the present disclosure, the side space may include a first side space DS2 formed between an edge of the inlet stack housing 210 in the −X-direction and an edge of the cooling plate 120 in the −X-direction, and a second side space DS3 formed between an edge of the outlet stack housing 310 in the +X-direction and an edge of the cooling plate 120 in the +X-direction.

The coolant flow space 230 may also face or contact the first side space DS2 and the second side space DS3, and the coolant may also cool the first side space DS2 and the second side space DS3.

The inlet stack housing 210 may be a plurality of stack housings 210 disposed above the inlet 132 in the −X-direction in FIG. 4. The coolant discharged from the inlet stack housing 210 may be introduced into the second outer cooling region 432.

For example, a width of the first side space DS2 in the X-axis direction may be a width in the X-axis direction between the second edge 121 disposed in an end of the cooling plate 120 in the −X-direction and the first edge 112 of the stack housing 110. A maximum value of a length of the first side space DS2 in the Y-axis direction of may be a maximum value of a length of the cooling plate 120 in the Y-axis direction.

Additionally, a width of the second side space DS3 in the X-axis direction may be a width in the X-axis direction between the second edge 121 disposed in an end of the cooling plate 120 in the +X-direction and the first edge 112 of the stack housing 110. A maximum value of a length of the second side space DS3 in the Y-axis direction may be a maximum value of a length of the cooling plate 120 in the Y-axis direction.

The coolant flow space 230 may also be disposed below the first side space DS2 and the second side space DS3 in the −Z-direction, and the coolant flow space 230 may face or contact the first side space DS2 and the second side space DS3.

An outer line of the first side space DS2 and an outer line of the second side space DS3 may include the second edge 121 of the cooling plate 120 and the plurality of first edges 112 of the plurality of stack housings 110. For example, in a region in which the plurality of stack housings 110 are spaced apart from each other in the Y-axis direction, the first edges 112 of the plurality of stack housings 110 may extend in the Y-axis direction so that the plurality of first edges 112 of the plurality of stack housings 110 may be continuous in the Y-axis direction. Additionally, in outermost stack housings 110, first edges 112 of the outermost stack housings 110 may extend to the second edge 121 of the cooling plate 120, so that the plurality of first edges 112 of the plurality of stack housings 110 may be continuous in the Y-axis direction.

The stack housings 110 may not be disposed in the first side space DS2 and the second side space DS3. In some cases, at least a partial region of a busbar assembly 160 described below may be disposed in the first side space DS2 and the second side space DS3, but the present disclosure is not limited thereto.

An inlet second outer cooling region 432a and the cross-sectional area increasing region CA1 may face each other in the first side space DS2, and an outlet second outer cooling region 432b may face the second side space DS3.

The separation space DS1 may be a space formed by the inlet stack housing 210 and the outlet stack housing 310 being spaced apart from each other in the longitudinal direction (X-direction) of the battery cell 10. The coolant flow space 230 may also face the separation space DS1. The first outer cooling region 431 and the cross-sectional area decreasing region CA2 may face each other in the separation space DS1.

The cross-sectional area increasing region CA1 may be disposed outside the separation space DS1, and the cross-sectional area increasing region CA1 may not face the separation space DS1 in the Z-direction. In this case, the cross-sectional area increasing region may be a region in which a value of the cross-sectional area of the coolant flow space 230 increases in a flow direction of the fluid or coolant, and the cross-sectional area decreasing region may be a region in which a value of the cross-sectional area of the coolant flow space 230 decreases in the flow direction of the fluid or coolant.

A region in which a value of the cross-sectional area of the coolant flow space 230 increases may be a region in which a value of the cross-sectional area of the coolant flow space 230 increases based on a direction in which the fluid or coolant flows from the inlet 132 to the outlet 133 in the coolant flow space 230. Additionally, a region in which the cross-sectional area of the coolant flow space 230 decreases may be a region in which a value of the cross-sectional area of the coolant flow space 230 decreases based on a direction in which the fluid or coolant flows from the inlet 132 to the outlet 133 in the coolant flow space 230.

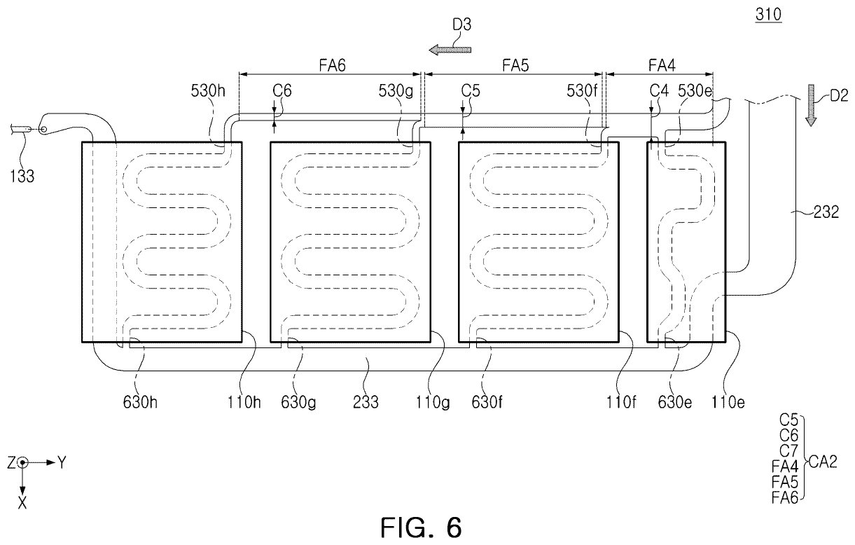

FIG. 5 is a schematic diagram of an inlet stack housing 210 including four stack housings 110 arranged in the first row, among a plurality of stack housings 110, and FIG. 6 is a schematic diagram of an outlet stack housing 310 including four stack housings 110 disposed in the second row, among a plurality of stack housings 110.

As illustrated in FIGS. 4 to 6, in an embodiment, the coolant may be supplied from a main flow region 231 to each stack cooling region 330. The main flow region 231 may be branched into each stack cooling region 330. The main flow region 231 may face the separation space DS1 and may thus include a first outer cooling region 431.

The coolant supplied from the inlet 132 to the coolant flow space 230 may be supplied to the first outer cooling region 431. Some of the coolant may flow in the main flow region 231 of the first outer cooling region 431, and the other thereof may be supplied to the coolant flow space 230 facing the inlet stack housing 210.

For example, the coolant flow space 230 may be branched from the main flow region 231 to each stack inlet region 530. The main flow region 231 may be connected to the inlet 132 and the stack inlet region 530 of the inlet stack housing 210.

The stack inlet region 530 of the inlet stack housing 210 may include a first stack inlet region 530a introducing the coolant into a first stack housing 110a, a second stack inlet region 530b introducing the coolant into a second stack housing 110b, a third stack inlet region 530c introducing the coolant into a third stack housing 110c, and a fourth stack inlet region 530d introducing the coolant into a fourth stack housing 110d.

The coolant may be supplied from the main flow region 231 to the stack cooling region 330 facing the inlet stack housing 210. In the main flow region 231, the coolant may flow in the first flow direction D1, and in each stack inlet region 530, the coolant may flow in a direction parallel to the X-axis, which is a direction, intersecting the first flow direction D1.

The coolant discharged from the stack cooling region 330 facing the inlet stack housing 210 may flow through the stack discharge regions 630 and may be introduced into the second outer cooling region 432.

Here, the second outer cooling region 432 may include an inlet second outer cooling region 432a that is a second outer cooling region 432 including a cross-sectional area increasing region CA1 and an outlet second outer cooling region 432b that is a second outer cooling region 432 that does not include a cross-sectional area increasing region CA1. The inlet second outer cooling region 432a and the outlet second outer cooling region 432b may be spaced apart from each other with the first outer cooling region 431 interposed therebetween.

In the second outer cooling region 432a of the inlet, the cross-sectional area increasing region CA1 may include a section in which a cross-sectional area of the coolant flow space 230 is a first cross-sectional area C1, a section in which the cross-sectional area thereof is a second cross-sectional area C2, and a section in which the cross-sectional area thereof is a third cross-sectional area C3. The section having the first cross-sectional area C1, the section having the second cross-sectional area C2, and the section having the third cross-sectional area C3 may continue for a certain section in the first flow direction D1. That is, each of the section having the first cross-sectional area C1, the section having the second cross-sectional area C2, and the section having the third cross-sectional area C3 may have a certain length in the Y-axis direction.

As illustrated in FIG. 5, in an embodiment of the present disclosure, the cross-sectional area increasing region CA1 may be disposed to follow the first stack discharge region 630a of the first stack housing 110a in the flow direction of the coolant, and may include a first flow region FA1 having the first cross-sectional area C1, a second flow region FA2 in which a second stack discharge region 630b of the second stack housing 110b adjacent to the first stack housing 110a and the first flow region FA1 are integrated and which has a second cross-sectional area C2, and a third flow region FA3 in which a third stack discharge region 630c of the third stack housing 110c adjacent to the second stack housing 110b and the second flow region FA2 are integrated and which has a third cross-sectional area C3. In this case, among the first cross-sectional area C1, the second cross-sectional area C2, and the third cross-sectional area C3, a value of the third cross-sectional area C3 may be the largest.

The coolant passing through the first stack discharge region 630a may be introduced into the first flow region FA1. Being disposed to follow in the flow direction of the coolant may denote may denote that the coolant is introduced relatively later.

The second flow region FA2 may be disposed to follow in the first flow direction D1 of the coolant with respect to the first flow region FA1, and the third flow region FA3 may be disposed to follow in the first flow direction D1 of the coolant with respect to the second flow region FA2. The coolant may flow through the first flow region FA1 first and may then flow through the second flow region FA2, and may flow through the third flow region FA3 after flowing through the second flow region FA2.

The coolant flowing through the third flow region FA3 may include a coolant discharged from a fourth stack discharge region 630d of the fourth stack housing 110d, a coolant discharged from the third stack discharge region 630c, and a coolant introduced from the second flow region FA2.

The third flow region FA3 may be connected to a direction change region 232, and the coolant may be introduced from the third flow region FA3 to the direction change region 232. The third flow region FA3 may be a region in which the coolant of the inlet stack housing 210 is discharged.

In an embodiment, in the first stack discharge region 630a, the second stack discharge region 630b, and the third stack discharge region 630c, the coolant may flow in a direction (+X-direction), intersecting the first flow direction D1. This may be achieved by disposing a pipe including the coolant flow space 230 in a direction (+X-direction), intersecting the first flow direction D1. In this manner, the flow direction of the coolant may be determined according to the shape in which the pipe including the coolant flow space 230 is disposed.

The coolant flow space 230 may include the first flow region FA1, the second flow region FA2, and the third flow region FA3. The first flow region FA1, the second flow region FA2 and the third flow region FA3 of the pipe including the coolant flow space 230 may be disposed in a direction (parallel to the Y-axis), intersecting the first stack discharge region 630a, the second stack discharge region 630b, and the third stack discharge region 630c.

In the pipe including the coolant flow space 230, the first flow region FA1 may extend to the second stack housing 110b. Additionally, the second flow region FA2 may extend to the third stack housing 110c, and the third flow region FA3 may extend to the fourth stack housing 110d.

In an embodiment, among the first cross-sectional area C1 and the second cross-sectional area C2, a value of the second cross-sectional area C2 may be the largest. Accordingly, among the first cross-sectional area C1, the second cross-sectional area C2, and the third cross-sectional area C3, a value of the first cross-sectional area C1 is the smallest, a value of the third cross-sectional area C3 is the largest, and the value thereof may increase linearly from the first cross-sectional area C1 to the third cross-sectional area C3.

The first cross-sectional area C1 is a cross-sectional area in the Z-axis direction in the first flow space of the pipe including the coolant flow space 230, and may be an area in the X-Z plane of the pipe including the coolant flow space 230 in the first flow space.

The second cross-sectional area C2 may be a cross-sectional area in the Z-axis direction in the second flow space of the pipe including the coolant flow space 230, and the third cross-sectional area C3 may be a cross-sectional area in the Z-axis direction in the third flow space of the pipe including the coolant flow space 230.

According to the above-described cross-sectional area increasing region CA1, among the first flow region FA1, the second flow region FA2 and the third flow region FA3, the flow velocity of the coolant in the first flow region FA1 may be the fastest, and the flow velocity of the coolant in the third flow region FA3 may be the slowest. Accordingly, the coolant may stay for a relatively long time in the third flow region FA3 disposed relatively farthest from the inlet 132, and a relatively long heat exchange time may be secured in the third flow region FA3.

Since the fourth stack housing 110d is relatively farthest from the inlet 132, the time at which the coolant arrives may be relatively later than that of the first stack housing 110a, the second stack housing 110b, and the third stack housing 110c. Accordingly, this problem may be compensated for by securing sufficient heat exchange time.

Additionally, by increasing the flow velocity in the first flow region FA1 to prevent stagnation of the coolant, smooth circulation of the coolant may be promoted. Additionally, as the cross-sectional area of the coolant flow space 230 sequentially increases in the cross-sectional area increasing region CA1, the coolant may be stably and uniformly supplied from the first stack housing 110a to the fourth stack housing 110d.

The coolant passing through the third flow region FA3 flows into the direction change region 232, and in the direction change region 232, the coolant may flow in the second flow direction D2.

As illustrated in FIG. 6, the coolant passing through the direction change region 232 may flow into a side discharge region 233. In the side discharge region 233, the coolant may flow in the third flow direction D3. The side discharge region 233 may be the outlet second outer cooling region 432b of the discharge section that does not include a cross-sectional area decreasing region CA2. The side discharge region 233 may be disposed outside an edge of the outlet stack housing 310 in the +X-direction.

Meanwhile, as illustrated in FIGS. 4 to 6, the outlet stack housing 310 may be spaced apart from the inlet section stack housing 210 in the X-axis direction, and the outlet stack housing 310 may face the inlet section stack housing 210. The first outer cooling region 431 and the cross-sectional area decreasing region CA2 may be disposed between the outlet stack housing 310 and the inlet stack housing 210.

The outlet stack housing 310 may include a fifth stack housing 110e spaced apart from the fourth stack housing 110d in the +X-direction and facing the fourth stack housing 110d, a sixth stack housing 110f spaced apart from the fifth stack housing 110e in the −Y-direction and neighboring the fifth stack housing 110e in the −Y-direction, a seventh stack housing 110g spaced apart from the sixth stack housing 110f in the −Y-direction and neighboring the sixth stack housing 110f in the −Y-direction, and an eighth stack housing 110h spaced apart from the seventh stack housing 110g in the −Y-direction and neighboring the seventh stack housing 110g in the −Y-direction. Among the outlet stack housings 310, the eighth stack housing 110h may be disposed closest to the outlet, and the fifth stack housing 110e may be disposed farthest from the outlet.

The main flow region 231 may be connected to the stack inlet region 530 of the outlet stack housing 310. The main flow region 231 may supply the coolant to the stack inlet region 530 of the outlet stack housing 310 in a region in which the coolant flows in the third flow direction D3. Conversely, the main flow region 231 may supply the coolant to the stack inlet region 530 of the inlet stack housing 210 in a region in which the coolant flows in the first flow direction D1.

The stack inlet region 530 of the outlet stack housing 310 may include a fifth stack inlet region 530e that introduces the coolant into the fifth stack housing 110e, a sixth stack inlet region 530f that introduces the coolant into the sixth stack housing 110f, a seventh stack inlet region 530g that introduces the coolant into the seventh stack housing 110g, and an eighth stack inlet region 530h that introduces the coolant into the eighth stack housing 110h.

In an embodiment, the cross-sectional area decreasing region CA2 may include a fourth flow region FA4 supplying the coolant to the fifth stack inlet region 530e of the fifth stack housing 110e facing the fourth stack housing 110d adjacent to the fourth stack housing 110d in a stacking direction, which is a direction in which the third stack housing 110c and a plurality of battery cells 10 are stacked, and having a fourth cross-sectional area C4, a fifth flow region FA5 disposed to follow the fourth flow region FA4 in the flow direction of the coolant and having a fifth cross-sectional area C5, and a sixth flow region FA6 disposed to follow the fifth flow region FA5 in the flow direction of the coolant and having a sixth cross-sectional area C6, and among the fourth cross-sectional area C4, the fifth cross-sectional area C5 and the sixth cross-sectional area C6, a value of the sixth cross-sectional area C6 may be the smallest.

The fourth flow region FA4 may include a region in which is disposed in advance in the flow direction of coolant with respect to the fifth stack inlet region 530e. The fourth flow region FA4 may face the fifth stack housing 110e. Additionally, the fourth flow region FA4 may be branched into the fifth stack inlet region 530e, the fifth flow region FA5, and the sixth stack inlet region 530f.

The meaning of being disposed in advance in the flow direction of the coolant may denote a region in which the coolant flows relatively first. For example, the coolant may flow into the fifth stack inlet region 530e after flowing through a region disposed in advance in the flow direction of the coolant with respect to the fifth stack inlet region 530e in the fourth flow region FA4.

The fifth flow region FA5 may be provided with the coolant not supplied to the fifth stack inlet region 530e from the fourth flow region FA4 and the coolant not supplied to the sixth stack inlet region 530f. The fifth flow region FA5 may face the sixth stack housing 110f.

The fifth flow region FA5 may be branched into the sixth flow region FA6 and the seventh stack inlet region 530g. The coolant not supplied to the seventh stack inlet region 530g may be supplied to the sixth flow region FA6. The coolant flowing through the sixth flow region FA6 may be supplied to the eighth stack inlet region 530h.

The coolants passing through each stack cooling region 330 facing each of the fifth, sixth, seventh and eighth stack housings 110 may be discharged to the stack discharge region 630. The stack discharge region 630 of the outlet stack housing 310 may include a fifth stack discharge region 630e discharging the coolant from the fifth stack housing 110e, a sixth stack discharge region 630f discharging the coolant from the sixth stack housing 110f, a seventh stack discharge region 630g discharging the coolant from the seventh stack housing 110g, and an eighth stack discharge region 630h discharging the coolant from the eighth stack housing 110h.

The fifth, sixth, seventh, and eighth stack discharge regions 630e, 630f, 630g and 630h may be connected to the side discharge region 233, and the coolant discharged from the fifth, sixth, seventh and eighth stack discharge regions 630e, 630f, 630g and 630h may pass through the side discharge region 233 and may be discharged to the outlet 133.

Meanwhile, the cross-sectional area of the coolant flow space 230 may linearly decrease from the fourth flow region FA4 to the sixth flow region FA6. For example, among the fourth cross-sectional area C4, the fifth cross-sectional area C5 and the sixth cross-sectional area C6, a value of the fourth cross-sectional area C4 may be the largest, and a value of the sixth cross-sectional area C6 may be the smallest. Accordingly, in the outlet stack housing 310, the flow velocity of the coolant may be the slowest in the fourth flow region FA4, and the flow velocity of the coolant may be the fastest in the sixth flow region FA6.

The flow velocity of the coolant may increase linearly from the fourth flow region FA4 to the sixth flow region FA6.

In the outlet stack housing 310, the sixth flow region FA6 may be disposed relatively closer to the outlet than the fourth flow region FA4. Accordingly, according to the cross-sectional area decreasing region CA2, the flow of the coolant may be prevented from stagnating near the outlet.

Meanwhile, in an embodiment, the cross-sectional area of the coolant flow space 230 in the cross-sectional area increasing region CA1 may sequentially increase within a range of 1.5 times or more and 2 times or less. For example, the second cross-sectional area C2 may be a value in the range of 1.5 times or more and 2 times or less than the first cross-sectional area C1. Additionally, the third cross-sectional area C3 may be a value in the range of 1.5 times or more and 2 times or less than the second cross-sectional area C2. Accordingly, a rapid increase in the cross-sectional area of the coolant flow space 230 may be prevented.

Additionally, even in the cross-sectional area decreasing region CA2, the cross-sectional area of the coolant flow space 230 may be reduced within the range of less than 1 time and 0.5 times or more. For example, a minimum value of the fifth cross-sectional area C5 may be a value corresponding to 0.5 times the fourth cross-sectional area C4. Additionally, a minimum value of the sixth cross-sectional area C6 may be a value corresponding to 0.5 times the fifth cross-sectional area C5.

According thereto, when the coolant is cooling water, considering the viscosity of the coolant, and the like, the coolant may be allowed to stay in the coolant flow space 230 for a sufficient time to cool the stack housing 110. Accordingly, the cooling performance of the coolant may be sufficiently exerted.

For example, a coolant for a vehicle may include a coolant such as water, ethylene glycol or propylene glycol, and antifreeze additives, but the type, components, and the like, of the coolant are not necessarily limited by the present disclosure.

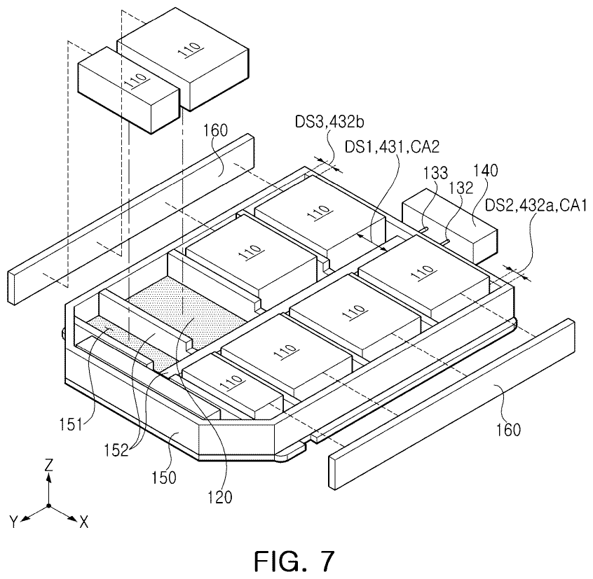

FIG. 7 is a partially exploded perspective view of a battery apparatus 100 according to an embodiment of the present disclosure.

As illustrated in FIG. 7, the battery apparatus 100 according to an embodiment of the present disclosure may further include an apparatus case 150 accommodating the plurality of stack housings 110 and the cooling plate 120, and including the separation space DS1 and the side space, and a busbar assembly 160 connected to the plurality of battery cells 10 and disposed in the side space.

The apparatus case 150 may include an internal space 151 accommodating the plurality of stack housings 110. The internal space 151 may include the separation space DS1 and the side space.

In an embodiment, the apparatus case 150 may include at least one partition member 152 dividing the internal space 151 into a plurality of spaces. At least one partition wall member 152 may be provided in plural, and the plurality of partition wall members 152 may be disposed to intersect each other. However, this is not necessarily limited by the present disclosure. A plurality of stack housings 110 may be accommodated in internal spaces 151 partitioned in plural.

In the apparatus case 150, the cooling plate 120 may be disposed in a lower portion of the battery cell 10 of the plurality of stack housings 110 in a height direction (Z-direction). The edge of the cooling plate 120 may extend to the outside of the edge of the stack housing 110.

In the apparatus case 150, the cooling plate 120 may contact or face the spaced space DS1, the side space, and the plurality of stack housings 110.

As illustrated in FIG. 1 and FIG. 7, the first electrode lead 11a and the second electrode lead 11b of the battery cell 10 accommodated in the plurality of stack housings 110 may be connected to the busbar assembly 160. The busbar assembly 160 may include a busbar member connected to the first electrode lead 11a and the second electrode lead 11b and an insulating plate supporting the busbar member.

In an embodiment, the cooling portion 140 may be disposed outside the apparatus case 150. However, the position of the cooling portion 140 is not necessarily limited by the present disclosure.

In an embodiment, the apparatus case 150 may be supported by a cross beam, a side beam, or the like, of the vehicle, or may be accommodated inside the vehicle. Additionally, as an example, the cooling portion 140 may be the cooling portion 140 of the vehicle.

Additionally, in an embodiment, the cooling plate 120 may be formed of a material including aluminum, and the cooling channel 130 may be a hollow portion formed in the cooling plate 120. Accordingly, the thermal conductivity of the cooling plate 120 may be increased. Additionally, when the hollow portion is provided in the cooling plate 120 to implement the coolant flow space 230, the cooling efficiency of the coolant flowing in the coolant flow space 230 may also be improved.

Additionally, in some cases, the material of the pipe provided in the cooling plate 120 may also include aluminum.

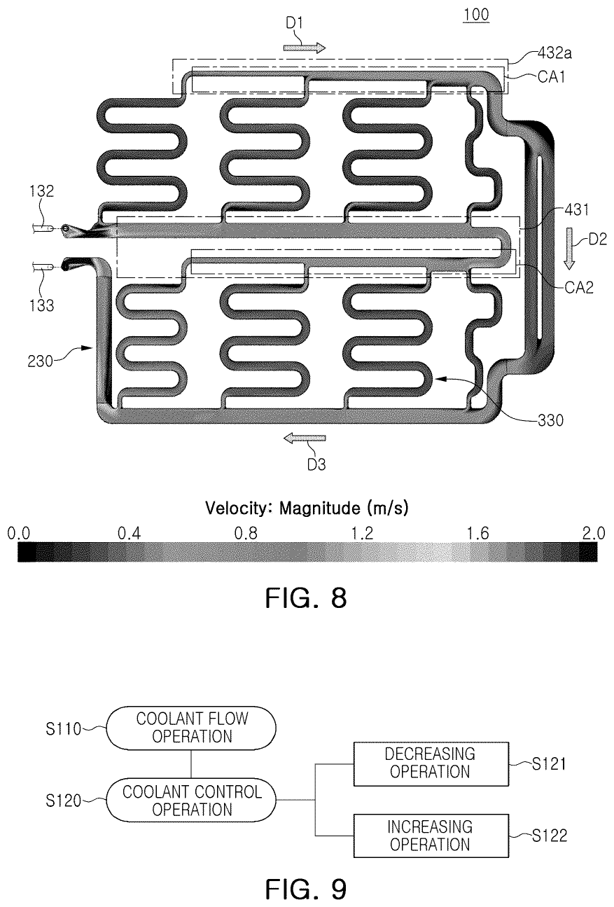

FIG. 8 schematically illustrates analysis results of a coolant flow velocity of the battery apparatus 100 according to an embodiment of the present disclosure, and is contour data. The analysis results are derived through computational fluid dynamics software known as “Simcenter STAR-CCM+.”

Referring to FIG. 8, the flow velocity of the coolant flowing in the coolant flow space 230 may be known. According to the present disclosure, the flow velocity of the coolant may be relatively fast in the first outer cooling region 431, and the coolant may be quickly introduced into the plurality of stack cooling regions 330. Additionally, the coolant may be introduced into each stack cooling region 330 while preventing the flow of the coolant from stagnating.

Additionally, by introducing the cross-sectional area decreasing region CA2 to the first outer cooling region 431, the flow stagnation may be prevented from occurring in the first outer cooling region 431 and the cross-sectional area decreasing region CA2. Accordingly, it may be possible to prevent the occurrence of a cooling deviation in the plurality of stack cooling regions 330 or a deviation in a cooling flow rate supplied to the plurality of stack cooling regions 330.

Additionally, the cross-sectional area increasing region CA1 may be introduced to the second outer cooling region 432a of the inlet, thereby preventing the flow stagnation from occurring in the second outer cooling region 432a of the inlet and the cross-sectional area increasing region CA1. Accordingly, the discharge of the coolant may be smoothly performed even in the stack cooling region 330 that is relatively far from the outlet 133.

According to the above-described disclosure, it may be possible to prevent the occurrence of a difference in cooling flow rate or cooling performance according to a position in which the stack housing 110 is disposed in the battery apparatus 100.

Additionally, it may be possible to prevent the occurrence of a cooling difference according to a length difference of the coolant flow space 230 from the inlet port 132 to each stack cooling region 330.

On the other hand, the present disclosure as another aspect provides a cooling method of a battery apparatus 100.

FIG. 9 schematically illustrates a cooling method of a battery apparatus 100 according to an embodiment of the disclosure. As illustrated in FIG. 9, a method of cooling a battery apparatus 100 according to an embodiment of the present disclosure may include a coolant flow operation (S110) of allowing the coolant to flow in the coolant flow space 230 in the stacking direction of the plurality of battery cells 10 and a coolant control operation (S120) of changing at least one of the flow velocity and the flow rate of the coolant in the coolant flow space 230.

The method of cooling a battery apparatus 100 may be a method for cooling any one of the battery apparatuses 100 described above with reference to FIGS. 1 to 8.

The flow velocity of the coolant may be a flow rate, which is the velocity at which the coolant flows.

In the coolant flow operation (S110), the coolant may be introduced into the coolant flow space 230 by the cooling portion 140. In the coolant flow operation (S110), the coolant may be supplied to each stack cooling region 330, and each stack housing 110 may be cooled.

In the coolant control operation (S120), the coolant may flow in the cross-sectional area increasing region CA1 and the cross-sectional area decreasing region CA2. At least one of the flow velocity and the flow rate of the coolant may be changed in a region in which the cross-sectional area of the coolant flow space 230 changes.

In an embodiment, the coolant control operation (S120) may include a decrease operation (S121) of linearly decreasing the flow velocity and an increase operation (S122) of linearly increasing the flow rate.

According to the coolant control operation (S120), at least one of the flow velocity and the flow rate of the coolant may be changed. Accordingly, it may be possible to prevent deviations in cooling performance or cooling efficiency depending on the shape of the coolant flow space 230, the distance between the coolant flow space 230 and the inlet 132, the distance between the coolant flow space 230 and the outlet.

The contents described above are merely examples of applying the principles of the present disclosure, and other components may be further included or other components may be substituted and applied without departing from the scope of the present disclosure.

What is claimed is:

1. A battery apparatus, comprising:
a stack housing accommodating a plurality of battery cells and provided in plural;
a cooling plate facing the stack housing; and
a cooling channel provided in the cooling plate and having a coolant flow space in which a coolant flows,
wherein the cooling channel includes regions in which values of a cross-sectional area of the coolant flow space are different from each other.

2. The battery apparatus of claim 1,
wherein in the cooling plate, an edge is disposed outside an edge of the plurality of stack housings, and
the coolant flow space includes:
a cross-sectional area increasing region in which a cross-sectional area increases in a flow direction of a coolant; and
a cross-sectional area decreasing region in which the cross-sectional area decreases in the flow direction of the coolant,
wherein the cross-sectional area increasing region and the cross-sectional area decreasing region are disposed outside the edge of the plurality of stack housings.

3. The battery apparatus of claim 2,
wherein the coolant flow space includes:
a plurality of stack cooling regions facing the plurality of stack housings; and
at least one outer cooling region connected to the plurality of stack cooling regions and not facing the plurality of stack housings,
wherein the at least one outer cooling region includes:
the cross-sectional area increasing region and the cross-sectional area decreasing region.

4. The battery apparatus of claim 3,
wherein at least one of the plurality of stack cooling regions includes:
at least one first extension portion extending in a stacking direction in which the plurality of battery cells are stacked.

5. The battery apparatus of claim 4,
wherein at least one of the plurality of stack cooling regions includes:
a plurality of first extension portions; and
at least one second extension portion connecting the plurality of first extension portions,
wherein at least one of the plurality of stack cooling regions is disposed in a curved manner.

6. The battery apparatus of claim 5,
wherein the plurality of first extensions are spaced apart from each other by a first interval.

7. The battery apparatus of claim 3, further comprising:
an inlet connected to the coolant flow space and through which the coolant is introduced; and
an outlet connected to the coolant flow space and through which the coolant is discharged,
wherein the at least one outer cooling region includes:
a first outer cooling region extending from the inlet and facing a separation space formed between the plurality of stack housings; and
a plurality of second outer cooling regions facing a side space formed between edges of the plurality of stack housings and an edge of the cooling plate.

8. The battery apparatus of claim 7,
wherein the first outer cooling region includes:
the cross-sectional area decreasing region, and
at least one of the plurality of second outer cooling regions includes:
the cross-sectional area increasing region.

9. The battery apparatus of claim 8,
wherein the coolant flow space further includes:
a plurality of stack inlet regions through which the coolant flowing into the plurality of stack cooling regions flows; and
a plurality of stack discharge regions through which the coolant discharged from the plurality of stack cooling regions flows,
wherein the coolant supplied from the first outer cooling region may be introduced into the plurality of stack inlet regions, and
the coolant discharged from the plurality of stack discharge regions flows in the plurality of second outer cooling regions.

10. The battery apparatus of claim 9,
wherein the cross-sectional area increasing region includes:
a first flow region disposed to follow a first stack discharge region of a first stack housing in the flow direction of the coolant and having a first cross-sectional area;
a second flow region integrating the first flow region and a second stack discharge region of a second stack housing adjacent to the first stack housing and having a second cross-sectional area; and
a third flow region integrating the second flow region and a third stack discharge region of a third stack housing adjacent to the second stack housing, and having a third cross-sectional area,
wherein, among the first cross-sectional area, the second cross-sectional area and the third cross-sectional area, a value of the third cross-sectional area is the largest.

11. The battery apparatus of claim 10,
wherein the cross-sectional area decreasing region includes:
a fourth flow region supplying the coolant to a fifth stack inlet region of a fifth stack housing facing a fourth stack housing adjacent to the third stack housing in a stacking direction in which a plurality of battery cells are stacked, and having a fourth cross-sectional area;
a fifth flow region disposed to follow the fourth flow region in the flow direction of the coolant and having a fifth cross-sectional area; and
a sixth flow region disposed to follow the fifth flow region in the flow direction of the coolant and having a sixth cross-sectional area,
wherein, among the fourth cross-sectional area, the fifth cross-sectional area and the sixth cross-sectional area, a value of the sixth cross-sectional area is the smallest.

12. The battery apparatus of claim 7,
wherein in the cooling channel, the inlet, the coolant flow space and the outlet form a closed loop, and
the coolant circulates through the closed loop.

13. The battery apparatus of claim 1,
wherein the cooling plate is formed of a material including aluminum, and
the cooling channel is a hollow portion formed in the cooling plate.

14. The battery apparatus of claim 7, further comprising:
an apparatus case accommodating the plurality of stack housings and the cooling plates, and including the separation space and the side space; and
a busbar assembly connected to the plurality of battery cells and disposed in the side space.

15. A battery apparatus, comprising:
an apparatus case;
a plurality of stack housings accommodated in the apparatus case and accommodating a plurality of battery cells;
a cooling plate facing the plurality of stack housings and including a coolant flow space therein;
an inlet connected to the coolant flow space and through which a coolant flows; and
an outlet connected to the coolant flow space and through which the coolant is discharged,
wherein the plurality of stack housings include:
at least one inlet stack housing and at least one outlet stack housing,
the at least one inlet stack housing and the at least one outlet stack housing are separated from each other to form a separation space, and
the coolant flow space includes regions in which values of a cross-sectional area of the coolant flow space are different from each other, and a cross-sectional area decreasing region, which is a region in which a value of a cross-sectional area of the coolant flow space decreases, is disposed to face the separation space.

16. The battery apparatus of claim 15,
wherein the cross-sectional area increasing region, which is a region in which a value of the cross-sectional area of the coolant flow space increases, is disposed outside the separation space.

17. A method for cooling a battery apparatus, the battery apparatus including: a stack housing accommodating a plurality of battery cells and provided in plural; a cooling plate facing the stack housing; and a cooling channel provided in the cooling plate and having a coolant flow space in which a coolant flows, wherein the cooling channel includes regions in which values of a cross-sectional area of the coolant flow space are different from each other,
wherein, to cool the battery apparatus, the method comprises:
a coolant flow operation of allowing a coolant to flow in the coolant flow space in a stacking direction of the plurality of battery cells; and
a coolant control operation of changing at least one of a flow velocity and a flow rate of the coolant in the coolant flow space.

18. The method for cooling a battery apparatus of claim 17, wherein the coolant control operation includes:
a decreasing operation of linearly decreasing the flow velocity; and
an increasing operation of linearly increasing the flow velocity.
